(19) United States
(12) Patent Application Publication
(10) Pub. No.: US 2009/0228217 A1
(43) Pub. Date: Sep. 10, 2009

(54) DEFECT INSPECTION METHOD

(76) Inventor: Tetsuya FUKUSHIMA, Kamiina (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/398,848

(22) Filed: Mar. 5, 2009

(30) Foreign Application Priority Data
Mar. 6, 2008 (JP) 2008-056170

(51) Int. Cl. G06F 19/00

(52) U.S. Cl. 702/35; 702/84; 382/149

(57) ABSTRACT

A recipe server executes an inspection region setup process for designating the inspection region of the object of inspection as the initial setting of a recipe; the recipe server executes optical condition setup process for setting an optical condition for the image pickup; a substrate inspection apparatus executes an image obtainment process for obtaining image data by picking up the image of the inspection object using a tentative recipe including the inspection region and optical condition which are designated by the recipe server; the recipe server executes a recipe tuning process for generating an adjusted recipe by tuning the tentative recipe using image data obtained by the substrate inspection apparatus; and the substrate inspection apparatus execute an inspection process for inspecting the inspection object on the basis of the adjusted recipe tuned by the recipe server.

### CROSS REFERENCE TO RELATED APPLICATIONS

This application claims the benefit of Japanese Application No. 2008-56170, filed Mar. 6, 2008, the contents of which are incorporated by this reference.

### BACKGROUND OF THE INVENTION

1. Field of the Invention

The present invention relates to a defect inspection method used for inspecting the presence and absence of a defect of a substrate such as a semi conductor wafer and a liquid crystal glass substrate.

2. Description of the Related Art

Conventionally, a substrate inspection apparatus used for inspecting a substrate, such as a semiconductor wafer and a liquid crystal glass substrate, as to whether or not a defect exists on the surface is known. Such a substrate inspection apparatus commonly performs several functions, e.g., setup of wafer design information such as setting an inspection region on the basis of a recipe, setup optical conditions when an image is picked up, obtainment of image data by means of image pick up, setup of various parameters such as threshold values to be used when defects are detected from the obtained image data, and categorization of defects resulting from the detection of defects on the basis of these conditions.

Meanwhile, conventional techniques that are known include, as a method for shortening time to generate a recipe to be used for a substrate inspection apparatus and a method of inspection with the optimal inspection condition in constant response to temporal changes when a substrate is inspected, as follows.

<First Conventional Technique>

To begin with, a first conventional technique, aiming at constantly performing an optimal inspection with a variation in a substrate inspection suppressed, is a method of calculating two threshold values using a plurality of pieces of image data (for example, refer to Laid-Open Japanese Patent Application Publication No. 2006-118870). In specific, the method is designed to register the smallest among the first threshold values as a reference image, compare the reference image with an inspection image and designate a minimum threshold value not constituting a pseudo-defect as the second threshold value.

Further, the method also includes a function of updating the reference image on an as required basis. It is also designed to have another apparatus called a tuning server execute the aforementioned function, thus preventing the substrate inspection apparatus from being occupied and improving a throughput.

<Second Conventional Technique>

Next, a second conventional technique, aiming at shortening time of generating a recipe to be used for a substrate inspection apparatus, is a method using a function capable of categorizing defects, thereby categorizing a true defect and false reports from the data of an inspection result (for example, refer to Laid-Open Japanese Patent Application Publication No. 2005-17159). In specific, the method is designed to automatically select a condition most suitable to the detection from among a plurality of inspection conditions using the aforementioned function of categorizing defects.

### SUMMARY OF THE INVENTION

A defect inspection method according to the present invention is the method used when a substrate belonging to a new product class is inspected at a defect inspection system to which both a substrate inspection apparatus used for inspecting a defect or defects by sequentially picking up respective images of a plurality of substrates and a recipe server used for setting a recipe to be utilized for the substrate inspection apparatus are connected by way of a network, the method including: an inspection region setup process for designating at least the inspection region of a substrate as the initial setting of the recipe for the substrate belonging to a new product class, the setting performed by the recipe server in the midst of inspecting another substrate belonging to another product class; an optical condition setup process for setting an optical condition for the image pickup; a tentative inspection process for the substrate inspection apparatus obtaining image data by picking up the image of the substrate using a tentative recipe including the inspection region and optical condition which are designated by the recipe server; a recipe tuning process for generating an adjusted recipe by modifying the tentative recipe using image data obtained by the substrate inspection apparatus, the process performed by the recipe server; and a main inspection process for the substrate inspection apparatus inspecting the substrate belonging to the new product class on the basis of the adjusted recipe modified by the recipe server.

### BRIEF DESCRIPTION OF THE DRAWINGS

The present invention will be more apparent from the following detailed description when the accompanying drawings are referred to.

FIG. 1 is a diagram for describing the entirety of a first preferred embodiment of the present invention;

FIG. 2 is a flow chart showing the flow of processing, according to the first embodiment of the present invention, the processing respectively executed in a substrate inspection apparatus and a recipe server;

FIG. 3 is a flow chart showing the flow of the tuning process in step S307;

FIG. 4 is a flow chart showing the flow of processing, according to a second preferred embodiment, the processing respectively executed in a substrate inspection apparatus and a recipe server;

FIG. 5 is a diagram for describing a graphical user interface (GUI) displayed in a substrate inspection system implementing the present invention;

FIG. 6 is a flow chart for describing the flow of a defect extraction process at inspection;

FIG. 7 is a diagram for describing another GUI displayed in a substrate inspection system implementing the present invention;

FIG. 8 is a flow chart showing the flow of the process for updating a rule file;

FIG. 9 is a diagram showing a search screen used for searching for an inspection image; and

FIG. 10 is a diagram showing a screen for setting three kinds of inspection judgment threshold values for each defect category name in a threshold value setup for each category of defect.

### DESCRIPTION OF THE PREFERRED EMBODIMENTS

### First Preferred Embodiment

The following is a description of the preferred embodiment of the present invention with reference to the accompanying drawings.

Here, “inspection” is defined as a series of processes starting from picking up the image of a substrate, to extracting a defect(s) from the picked-up image, to categorizing the extracted defects.

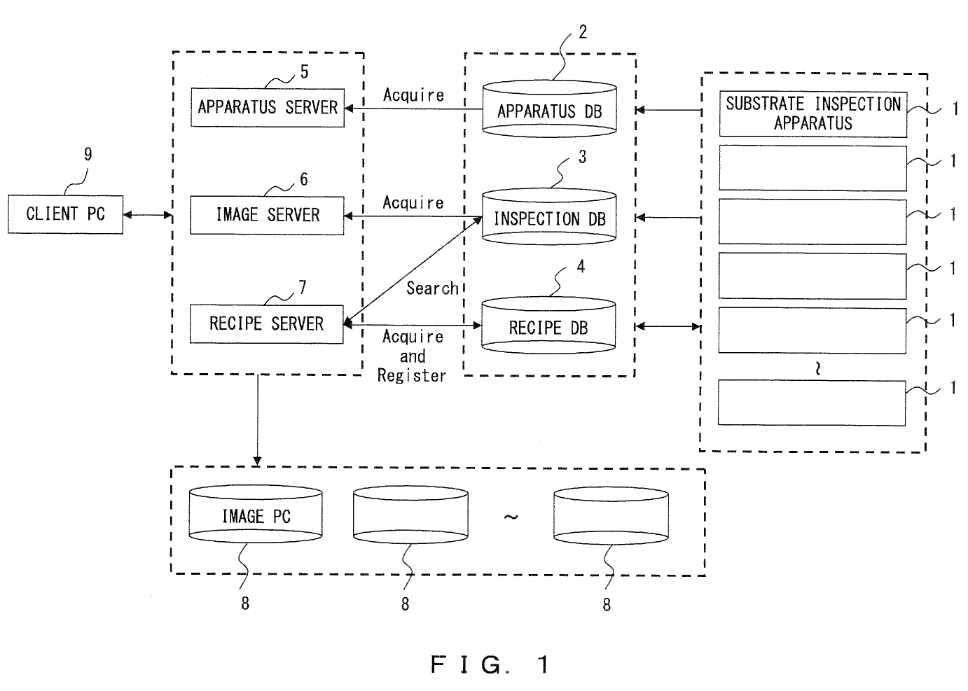

FIG. 1 is a diagram for describing the entirety of a first preferred embodiment of the present invention.

Referring to FIG. 1, the embodiment of the present invention primarily comprises three units, i.e., a substrate inspection apparatus unit, a database unit (noted as “DB” hereinafter) and a server unit.

The substrate inspection apparatus unit comprises substrate inspection apparatuses 1, each of which picks up the image of one or two (or more) wafers in accordance with the purpose and performs an inspection, are arranged on a production line. The database unit comprises an apparatus DB2, an inspection DB3, and a recipe DB4. The server unit comprises an apparatus server 5, an image server 6 and a recipe server 7.

The substrate inspection apparatus 1 is an inspection apparatus comprising: a transport apparatus used for extracting a wafer from a transport carrier and transporting it to an inspection-use stage; an illumination apparatus used for illuminating with a line-like illumination light; an image pickup apparatus consisting of a line sensor; a control unit used for having image picked up which moving the stage and controlling each apparatus; an image processing apparatus used for processing the pickup image, extracting a defect(s) and categorizing them; an operation unit used for operating the inspection apparatus and inputting various information; and a display unit used for displaying various images. The inspection apparatus is not limited to the image pickup method in the aforementioned form, and rather may use a method employing a two-dimensional imaging element.

The substrate inspection apparatus is also configured in such a manner to change illumination angles and image pickup angles, both of which are angles relative to the perpendicular of a substrate surface of the illumination apparatus and image pickup apparatus, respectively, at picking up image, so that the items of image pickup such as bright field, dark field and diffraction light observations, that is, the image pickup modes can be changed.

Note that a wafer inspected at the substrate inspection apparatus 1 is transported by the transport carrier The transport carrier is capable of accommodating commonly 25 pieces of wafers. There are various cases in which all 25 wafers belong to the same product class and same lot, or in which all 25 wafers belong to the same product class that includes plural lots, or in which 25 wafers belong to plural product categories.

The apparatus DB2 manages apparatus information that is a collection of various kinds of information obtained as a result of operating the apparatuses, such as the operating rates of the apparatuses of the substrate inspection apparatus 1, the number of inspected substrates, the number of defective substrates, a throughput, and the like. The apparatus information of the substrate inspection apparatus 1 while it is engaged in the inspection is stored in the apparatus DB2.

The inspection DB3, in which the raw image that has been imaged and picked up at the substrate inspection apparatus 1 and the inspection result that has been subjected to a defect extraction process and defect-categorized are registered, manages these pieces of inspection result data of the substrates.

The recipe DB4 manages the latest recipe that is generated, and updated, in the recipe server 7 (which is described later).

Note that a plurality of these apparatuses, i.e., the apparatus DB2, inspection DB3 and recipe DB4, may be provided.

Further, the substrate inspection apparatus 1, being connected to the apparatus DB2, inspection DB3 and recipe DB4 by way of a network, constantly downloads the latest recipe from the recipe DB4 and carries out inspection on the basis of the recipe.

The apparatus server 5, in which an application program is installed, is capable of browsing the information related to the apparatuses, the information registered in the apparatus DB2 that is connected by way of the network.

The image server 6, in which an application program is also installed, is capable of browsing the information related to inspection, such as inspection result images or defect data, which are registered in the inspection DB3 that is connected by way of the network.

Likewise, the recipe server 7, in which an application program is also installed, is capable of browsing information related to the recipe that is registered in the recipe DB4 connected by way of the network and of registering updated recipe. Furthermore, the recipe server 7 is also connected to the inspection DB3 by way of the network and is capable of downloading inspection result data.

Note that a plurality of apparatus servers 5, image servers 6 and recipe servers 7, respectively, may be equipped.

Here, the apparatus server 5, image server 6 or recipe server 7 is capable of freely extracting data registered in the apparatus DB2, inspection DB3 or recipe DB4.

Further, the apparatus server 5, image server 6 or recipe server 7 may be substituted by a personal computer (PC) or the like, provided that a software program enabled to access the apparatus DB2, inspection DB3 or recipe DB4 is installed in the PC or the like.

There is a plurality of image PCs 8, which respectively perform image processing for extracting a defect(s) if there is an instruction for a tuning (which is described later) of the recipe instructed by an inspector operating the recipe server 7.

Further, a client PC9 is connected to the apparatus server 5, image server 6 and recipe server 7 by way of the network and accesses the apparatus DB2, inspection DB3 or recipe DB4 using the application program installed in the apparatus server 5, image server 6 or recipe server 7, thereby utilizing the respective piece of data information.

Further, a host computer (which is not shown in a drawing here) is equipped for grasping the operating situation of the substrate production equipment, the transporting situation of the substrates and the like information and transmitting information as to which category of the substrate is next transported to each substrate inspection apparatus 1 to be inspected.

Next is a description of the flow of processing respectively executed in the substrate inspection apparatus 1 and recipe server 7 according to the first embodiment of the present invention.

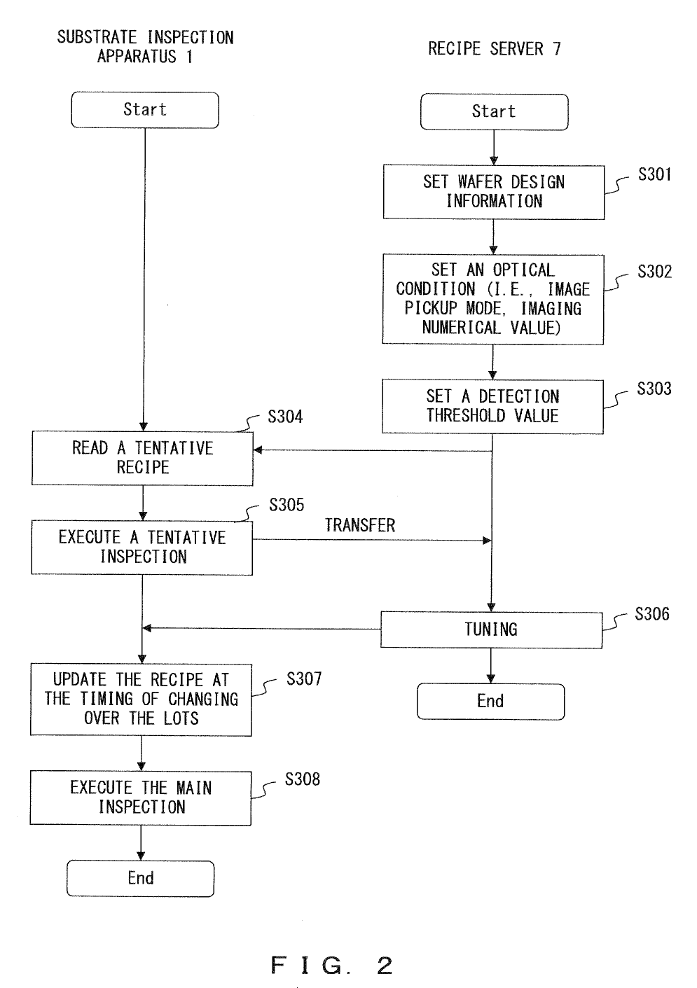

FIG. 2 is a flow chart showing the flow of processing, according to the first embodiment of the present invention, the processing respectively executed in a substrate inspection apparatus and a recipe server.

The premise here is that the present flow chart is started when the substrate inspection apparatus 1 receives a notice from the host computer that a wafer in a new product class, for which a recipe is not yet generated, will be next transported to the substrate inspection apparatus 1 while a wafer in a certain product class is presently inspected in the substrate inspection apparatus 1. Here, let it present a flow starting with: generating a tentative recipe in which the wafer design information and optical condition are specified at the recipe server 7; obtaining the image of the wafer at the substrate inspection apparatus 1 on the basis of the tentative recipe; carrying out a tuning in which the tentative recipe is modified on the basis of the obtained image of the wafer in the new product class; and ends with inspecting the wafer using the modified recipe generated by updating the tentative recipe.

First in step S301 (i.e., an inspection region setup process) (also simply noted as “S301” hereinafter), the recipe server 7 obtains the information of a region, in which the pattern of the wafer pre-stored in the recipe DB4 is formed, as the design information of the wafer that is the target of the next inspection, and designates an inspection region. Further, if the design information is not pre-stored in the recipe DB4, the inspector is enabled to manually input it on the recipe server 7.

Then, in S302 (i.e., an optical condition setup process), the recipe server 7 sets the optical condition on the basis of the instruction of the inspector. In specific, the recipe server 7 selects an image pickup mode that is an optical condition determined by the angle with which the image of a wafer is picked up, such as bright field imaging, dark field imaging and diffraction light imaging, and also inputs, and sets, numerical values (i.e., imaging numerical values) such as an illumination angle, an imaging angle, the volume of light (noted as “light volume” hereinafter) of the illumination apparatus, the numerical values which are used when the image is picked up in each respective image pickup mode. Note that the assumption here is a plurality of setup values is set for each image pickup mode because the best value is not yet known until an image is picked up. Further, an alternative configuration may be such that, if a pre-set setup value to be used, as default value, related to the image pickup mode and imaging numerical values is stored in the recipe DB4, the recipe server 7 automatically reads the value and sets it in S302.

In S303, the recipe server 7 reads, from the recipe DB4, a pre-set default setup value for setting up a defect judgment threshold value (i.e., a defect detection condition) to be used when a defect(s) is detected from a picked-up image, a categorization rule to be used when the detected defects are categorized, and the like, which are stored in the recipe DB4, and automatically set them. Likewise the step S301, the inspector is also enabled to input them by operating the recipe server 7.

As such, a recipe is tentatively generated, that is, a tentative recipe is generated, as the initial setup of a recipe in steps S301, S302 and S303. The tentative recipe is transferred to the recipe DB4 and is stored therein. Note that the sequence of S301, S302 and S303 can be set discretionarily. Here, the image pickup mode, imaging numerical value, defect judgment threshold value, and categorization rule to be used when defects are categorized are collectively called “inspection condition”. It is also possible to generate a plurality of tentative recipes of inspection conditions, and store them with the respective version numbers assigned to them, on an as required basis.

Then in S304, the substrate inspection apparatus 1 reads the tentative recipe from the recipe server 7 simultaneously with the carry-in of a wafer belonging to the new production category as the object of inspection.

In S305 (i.e., a tentative inspection process), the substrate inspection apparatus 1 sets the image pickup mode and imaging numerical values, that is, the angle at the image pickup, the light volume of the illumination apparatus, and the like, using the tentative recipe and picks up the image of the wafer. Then it extracts a defect(s) from the picked-up image data. That is, the defect is extracted by means of a known proximity comparison method that is used for extracting a defect by comparing each pair of adjacent patterns of an image in which a plurality of the same feature patterns is formed. In this event, a defect or defects are detected using the defect judgment threshold value designated by the tentative recipe. Then, the defects are categorized in accordance with the categorization rule of the tentative recipe. The inspection result data including the information of the obtained image data and that of the result of defect categorization is transferred to the recipe DB4 and inspection DB3 every time the inspection processes starting from obtaining the image of one wafer to completing the categorization of defects. Upon completion of a series of inspection processes, the inspection for the next wafer continues. Here, even if the image data and inspection data taken in the tentative inspection process uses the tentative recipe, they are treated as a normal inspection result.

Note that an alternative configuration may be such that the substrate inspection apparatus 1 only picks up the image of a wafer to send the image data to the recipe server 7 at every time the image is picked up and such that the recipe server extracts defects and categorizes them.

Next in S306 (i.e., a recipe tuning process), the recipe server 7 receives the inspection result data including the image data obtained by the substrate inspection apparatus 1 in S305 and generates an adjusted recipe by tuning the tentative recipe using the image data. Here, the “tuning” points to the inspector's actions including: eliminating an unnecessary image pickup mode by judging the necessity of the image pickup mode on the basis of the obtained image data; selecting a defect judgment threshold value so as to prevent the occurrence of erroneous detection of a defect by changing the defect judgment threshold values of the image data and carrying out a defect extraction process; selecting a categorization rule by changing the categorization rules so as to prevent an erroneous categorization if there is an erroneous categorization in the display of the result of the defect categorization; carrying out a defect extraction process and a defect categorization process by actually changing parameters to judge whether or not the parameters, such as the image pickup mode, defect judgment threshold value and categorization rule, are appropriate; and determining the appropriate parameters by judging while looking at the image.

In the meantime, the substrate inspection apparatus 1, while continuing the inspection on the basis of the tentative recipe that is read in S304, updates the tentative recipe, in S307, to the adjusted recipe, which has been tuned in S306, at the timing of changing lots belonging to the same product class of the wafer.

Then in S308 (i.e., a main inspection process), the substrate inspection apparatus 1 inspects the wafer on the basis of the updated adjusted recipe.

Incidentally, if the inspection conditions such as image pickup modes and imaging numerical values are assigned with the numbers as several versions and have been used for the tentative inspection process of S306, one piece of the image data corresponding to any one of the recipe versions can be selected to carry out a tuning using the selected image data.

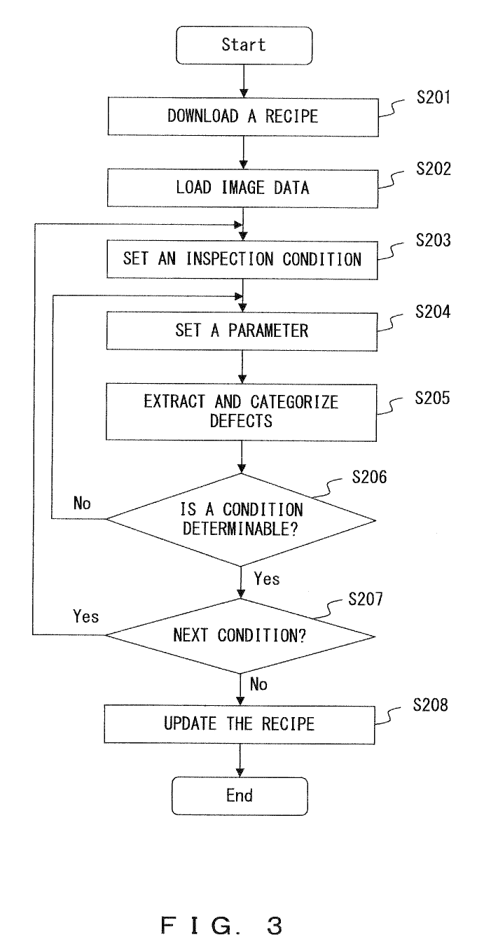

FIG. 3 is a flow chart showing the flow of the tuning process in step S307.

The premise here Is that a plurality of optical conditions is registered in the present recipe. That is, the optical condition includes the image pickup modes such as a bright field imaging, a dark field imaging and a diffraction light imaging, the imaging numerical values such as the illumination image, imaging angle and light volume of each image pickup mode. A plurality of conditions is set for each mode. Further premise is that the optical condition is set in the tentative recipe so that the image of the wafer is picked up at the substrate inspection apparatus 1 in accordance with the tentative recipe and so that the picked-up image data is stored in the inspection DB3.

First in S201, the recipe server 7 downloads the tentative recipe, which is used at the substrate inspection apparatus 1, from the recipe DB4 to the recipe server 7 on the basis of the instruction of the inspector.

In S202, the recipe server 7 designates the image data of the wafer, the data which is the object of tuning and which is stored in the inspection DB3, on the basis of the instruction of the inspector.

Then in S203, the recipe server 7 designates as to which of the image pickup modes of the optical conditions of the image data of the object wafer and an image picked up with which numerical value of the image pickup mode, on the basis of the instruction of the inspector.

In S204, the recipe server 7 changes, and sets, respective parameters of the inspection condition such as the defect judgment threshold value for extracting a defect(s) on the basis of the instruction of the inspector.

Then in S205, the recipe server 7 executes processes, such as the defect extraction process and defect categorization process, using the threshold value set in S204 in accordance with the parameter of the inspection condition set in S203 on the basis of the instruction of the inspector.

Then in S206, the inspector looks at the process result displayed on the display unit of the recipe server 7 to judge the appropriateness of the result of the process carried out in S205 and, if a good result is not obtained (i.e., “no” for S206), instructs the recipe server 7 so as to repeat the processes of S204 and thereafter. In contrast, if the result of the process carried out in S205 is good (i.e., “yes” for S206), then the process proceeds to S207.

In S207, in order to carry out an inspection under the inspection condition of an image pickup mode that is different from the optical condition set in S203, the inspector judges whether or not another different inspection condition exists. If a different inspection condition exists (i.e., “yes” for S207), the inspector instructs the recipe server 7 so as to repeat the steps S203 and thereafter under the next inspection condition and, when the inspection is completed with all the inspection conditions (i.e., “no” for S207), the recipe is updated in S208, and the process ends.

Then, the adjusted recipe is replaced at the timing of changing over the product lots, and the substrate inspection apparatus 1 continues the inspection.

The present first embodiment is configured to carry out the inspection method as described above, making it possible to execute an inspection using a tentative recipe even while the tentative recipe is being modified and picks up no particular image for the substrate inspection apparatus 1 setting the recipe and therefore a throughput of the entire system is improved and also a shift to an inspection under the optimal condition is quick.

### Second Preferred Embodiment

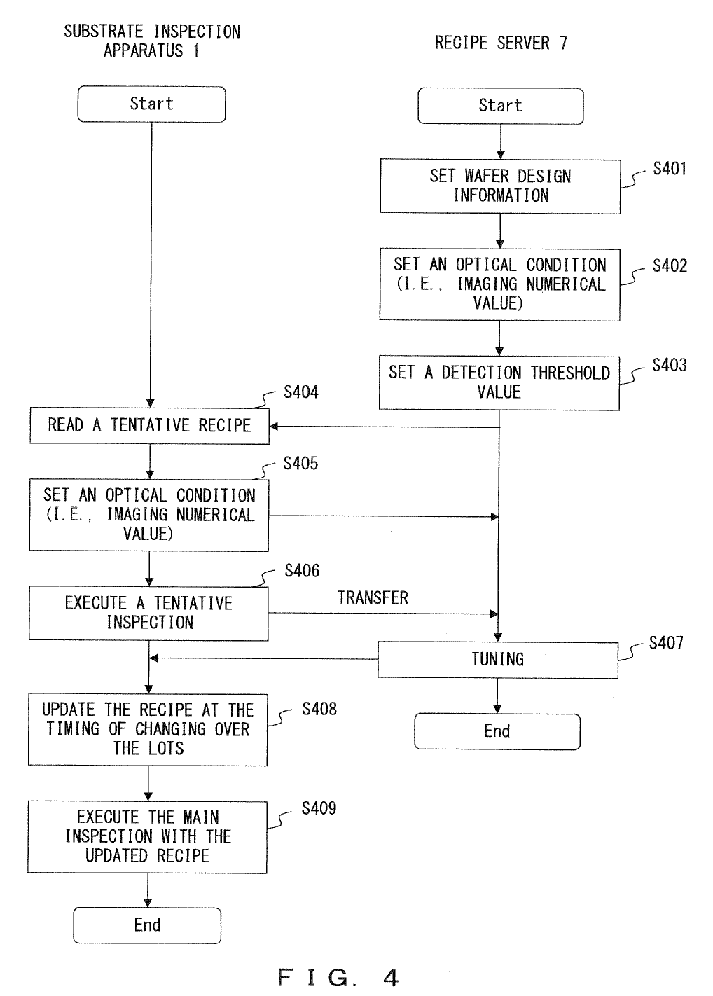

FIG. 4 is a flow chart showing the flow of processing, according to a second preferred embodiment, the processing respectively executed in a substrate inspection apparatus and a recipe server.

Let it describe the flow of a process according to the second embodiment with reference to FIG. 4. The major difference from the process of the first embodiment is where the present embodiment is configured such that the inspector determines the imaging numerical value of an optical condition using the substrate inspection apparatus 1.

The following description is mainly focused on the difference from the first embodiment. The process flow is started when the information of performing an inspection of a wafer which is a new product class and which has no set recipe is received, as in the case of the first embodiment.

The comprisal of the inspection system is the same as that of the first embodiment shown in FIG. 1.

The processes for setting a tentative recipe in the steps S401 through S403 are similar to those of the first embodiment, other than that only an image pickup mode is set in the optical condition setup of S402.

Then in S404, when a wafer in a new product class is carried onto the substrate inspection apparatus 1, a tentative recipe is read from the recipe server 7. Here, the tentative recipe includes the inspection region set by the recipe server 7, a categorization rule and the like.

When the inspector inputs, from the operation unit of the substrate inspection apparatus 1 by way of the recipe server 7, imaging numerical values such as the illumination angle, the imaging angle and the light volume of illumination light, which are not set by the previous optical condition setup, in the optical condition setup of S405, the imaging angles, and the like, of the image pickup apparatus are changed on the basis of the set value and the image of the wafer is actually picked up. Then, a defect(s) is extracted from the picked-up image and the defects are categorized. The inspection result is displayed on the display unit of the substrate inspection apparatus 1. The inspector judges as to which angle whose diffraction light of the order of diffraction is to be observed and, if a favorable result is riot obtained, changes the imaging numerical value and causes the substrate inspection apparatus 1 to carry out an inspection starting from picking up an image to categorizing the defects once again. The optimal imaging numerical value is determined by repeating such changes for a number of times. Likewise, the imaging numerical value is set in each image pickup mode to change the tentative recipe. Further, an image pickup mode maybe eliminated if a good inspection result cannot be obtained by picking up an image using the mode. The post-change tentative recipe is transferred to the recipe server 7.

In S406, a tentative inspection is started using the post-change tentative recipe.

Although the recipe tuning process of S407 is basically similar to that of the first embodiment, the optical condition is already tuned and therefore it is not required here. The processes that follow are similar to those of the first embodiment.

Related to the optical condition, the present second embodiment is configured such that the substrate inspection apparatus 1 performs an actual image pickup to determine the image pickup mode and imaging numerical value and then carry out a tentative inspection. Therefore, there is no need to carry out inspections in plural optical condition during the tentative inspection, making it possible to start a tuning early.

Next are descriptions of graphical user interface (GUI) and other functions, which are common to the first and second embodiments.

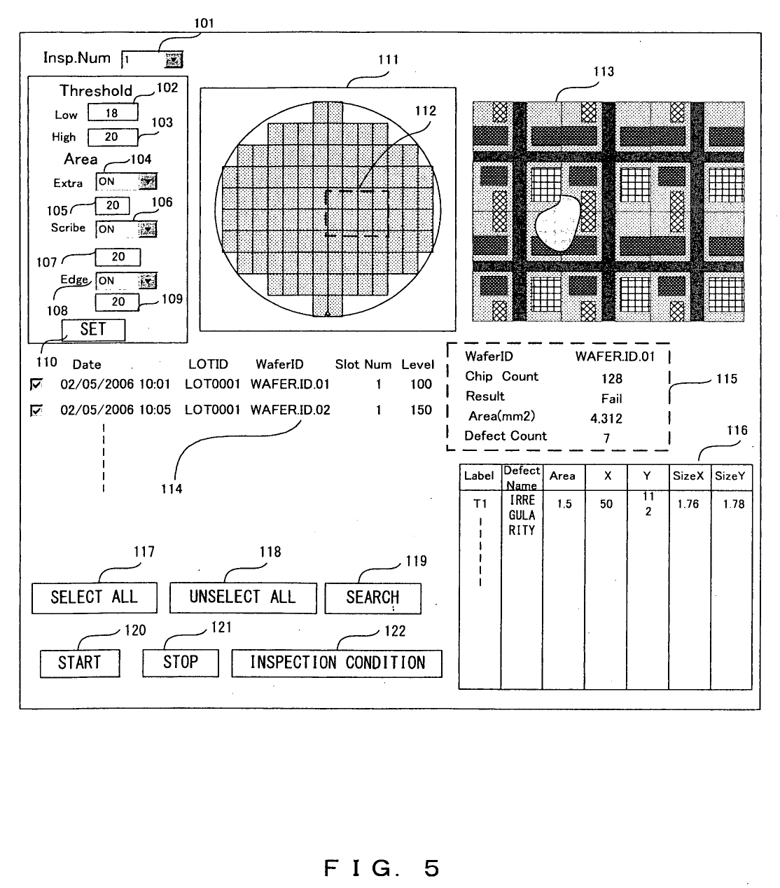

FIG. 5 is a diagram for describing a GUI displayed in a substrate inspection system implementing the present invention.

A substrate inspection system implementing the present invention has a configuration to search for an image stored in the inspection DB3 using the recipe server 7 and select a necessary inspection image, thereby making it possible to carry out a defect extracting inspection.

A select field 101 selects an inspection number for determining as to under which inspection condition an inspection is to be carried out. Information necessary for the inspection, such information as the inspection method, optical condition and defect categorization method are determined by the selected inspection number.

An input field 102 is a field used for an input when a large defect area size is desired to be taken by a threshold value on the low side of a defect judgment threshold value and the size is adjusted by a threshold value inputted here. Further, an input field 103 is a field for inputting a threshold value on the high side of a defect judgment threshold value so that the number of defects is varied by the inputted threshold value.

A select field 104 is a field used for determining whether or not the Extra region (i.e., the region other than the chip, scribe line and edges) is to be inspected, while an input field 105 is a field used for setting the defect judgment threshold value for the Extra region.

A select field 106 is a field used for determining whether or not the Scribe region is to be inspected, while an input field 107 is a field used for setting the defect judgment threshold value for the Scribe region.

A select field 108 is a field used for determining whether or not the Edge region is to be inspected, while an input field 109 is a field used for setting the defect judgment threshold value for the Edge region.

Further, the button of a select field 110 is used for storing the setup value inputted or selected by the input field 102, input field 103, select field 104, input field 105, select field 106, input field 107, select field 108 and input field 109. The operator (i.e., the inspector) carries out the inspection while adjusting the respective parameters with these setup values, and judges the appropriateness of the result.

An inspection result image 111 is an inspection result image output after inspecting by pressing a select button 120 for starting the inspection, and a region 112 is a view used for determining a part, of the inspection result image 111, to be desirably enlarged. Further, an enlargement image 113 shows the enlarged image of a part designated by the region 112. The designating parts of the region 112 can be changed by, for example, clicking the inspection result image 111 with a mouse.

A table list 114 is a list of inspection images allowing a random selection of an image to be desirably inspected.

A test result 115 shows the respective items indicating inspection result. “Chip Count” represents the total number of chips, “Result” represents the inspection result, “Area” represents the total area size of defects, and “Defect Count” represents the total number of defects.

A list 116 is a list of the information of the detected defect (s), and designating the “Label” column in the list moves the region 112 to the selected defect position and the enlarged image of the defect is displayed in the enlargement image 113.

A select button 117 is a button used for selecting the images displayed in the table list 114 in a lump so that the selecting of the select button 117 and the selection of the select button 120 prompt inspection of all images to be carried out.

In contrast, a select button 118 is a button used for unselecting the images displayed by way of the table list 114 in a lump.

Further, a select button 119 is a button used for bringing up a search screen for searching for an inspection image; the select button 120 is used for starting an inspection; a select button 121 is used for cancelling the inspection in its midst; and a select button 122 is used for displaying a dialog expressing an inspection condition.

First, designating the select button by means of a mouse click or the like in the substrate inspection system comprising such a GUI, a screen enabling the selection of an inspection image is brought up. Searching for an image to be desirably inspected and selecting it in the screen, the inspection image information is brought up as a list in the table list 114. The information of the date, Lot ID, Wafer ID and Level (i.e., the minimum threshold value to be not detected as a defect) is displayed in the table list 114. Further, the inspection number of the inspection condition of an image to be inspected is designated in the select field 101.

Then, the threshold values used for determining a defect judgment are set by way of the input fields 102 and 103, select field 104, input field 105, select field 106, input field 107, select field 108, input field 109 and select button 110. Note that the designation of un-testing respective regions can be set by way of the select fields 104, 160 arid 108 in an inspection related to the Extra region, Scribe region and Edge region.

Then, the inspection is started when the select button 120 is clicked with a mouse, or the like operation, after an inspection image is selected from the list of the table list 114.

Designating the Wafer ID of each image listed in the table list 114 after the completion of the inspection brings up the inspection result image in an inspection result screen 111 and brings up an enlarged image of the region 112 in the enlargement image 113. Note that the areas of the region 112 can also be changed by designating it on the inspection result screen 111 by clicking with a mouse or the like. Further, the Chip Count (i.e., the total number of chips), Result (i.e., the result of inspection), Area (i.e., the total area size of defect) and Defect Count (i.e., the number of defects) of the designated Wafer ID are brought up in an inspection result 115.

If the inspection needs to be cancelled in the midst thereof, the designation of the select button 121 will end the inspection.

An appropriate defect judgment threshold value can be set by performing a pre-inspection by variously changing the defect judgment threshold value.

Next is a description of the outline of an actual representative defect extraction process.

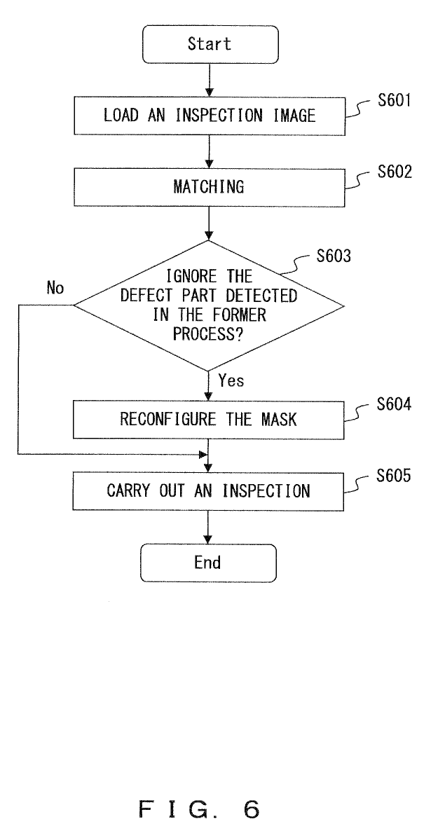

FIG. 6 is a flow chart for describing the flow of a defect extraction process at inspection.

First, an image as the object of inspection (noted as “inspection object image” hereinafter) is loaded in S601 and the process for matching between the inspection object image and a model image (i.e., a base image) is carried out in S602.

Then in S603, whether or not the mode to ignore an already detected defect is turned ON is judged and, if the judgment is that it is turned ON (i.e., “yes” for S603), a mask image for cancelling the defect part is reconfigured in S604. The specific method is to obtain the inspection result of the same wafer ID by the name of the process noted in the recipe file (or in the lot ID and slot No.) from the image server 6 and eliminate the chip region, which is identified to be a defect as the inspection result, from the region of the inspection object.

After the master image is reconfigured in S604, or if the judgment of S603 is that the mode to ignore the defect part already detected is not turned ON (i.e., “no” for S603), the detection of a defect is carried out in S605.

The embodiment is configured to use the recipe server 7 to tune an inspection and update the recipe that sets the optimal inspection condition as described above, making it possible to always perform an accurate inspection and also prevent the substrate inspection apparatus 1 from being occupied, thereby enabling an improvement in the throughput.

Note that the present invention is not limited by the above described embodiment and rather may use a method as follows.

For instance, there is a case in which what kind of image is used for an inspection is not known when the inspection is carried out. In such a case, only images are obtained in a plurality of optical conditions in advance the inspection using a tentative recipe generated in a non-test mode (i.e., an Acquire mode) by using the substrate inspection apparatus 1. Thereafter, an image picked up with an appropriate optical condition can be selected by carrying out inspections by changing threshold value using these images.

Next is a description of another preferred embodiment to which the present invention is applied.

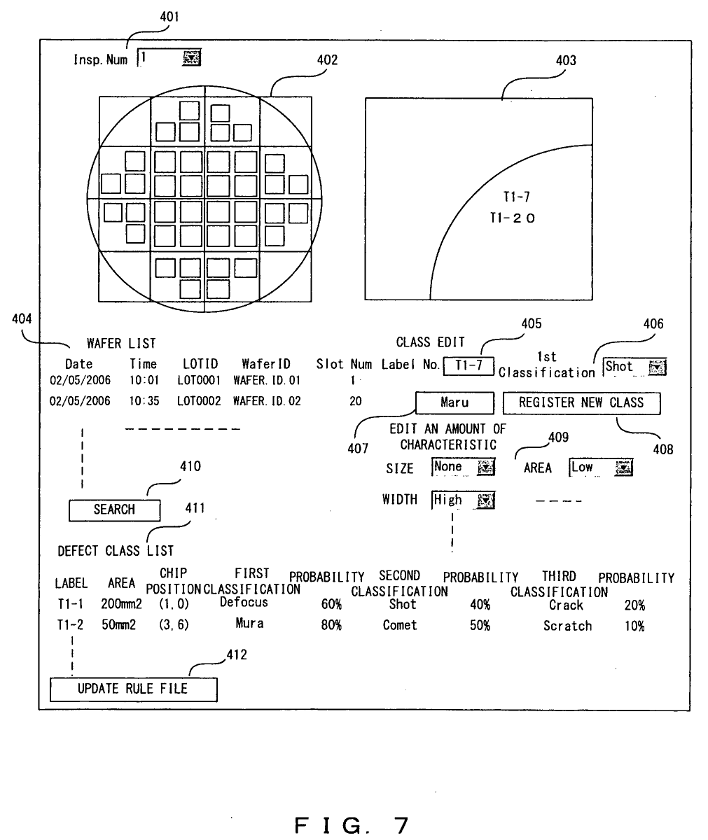

FIG. 7 is a diagram for describing another GUI displayed in a substrate inspection system implementing the present invention.

The substrate inspection system implementing the present invention is capable of not only updating a recipe but also updating a defect category file. As an actual usage of the substrate inspection system, there is a case of not only for extracting a defect(s), but also for categorizing the extracted defects in order to help improve the production yield.

A select field 401 is provided for selecting an inspection number in order to determine as to under which inspection condition an inspection is to be carried out. A select image 402 displays the image of wafer design information, and an enlargement image 403 displays the enlarged image of a wafer attached with a label identifying a deflect (noted as “defect label” hereinafter).

A wafer list 404 is a list of wafer images so that the designating of a Lot ID in the list by clicking it with a mouse, et cetera, causes the designated wafer image to be displayed in the enlargement image 403.

A display field 405 displays a defect label and also a defect category name that is the first candidate of the defect label. Further, an input field 407 is a column enabled to define a new classification (shown as “class” in the figure) so that the input of a class name here and the designation of the button of a select button make it possible to register a new class name.

A select field 409 is a field used for selecting an amount of characteristic that determines the definition of a class. A select button 410 is a search button used for searching for a wafer image and displaying it in the wafer list 404, and a defect class list 411 displays a list of defect classes is a catalog. Further, the designating of a select button 412 by clicking it with a mouse or the like operation updates a rule file.

Next is a description of the updating process for the rule file performed at the recipe server 7.

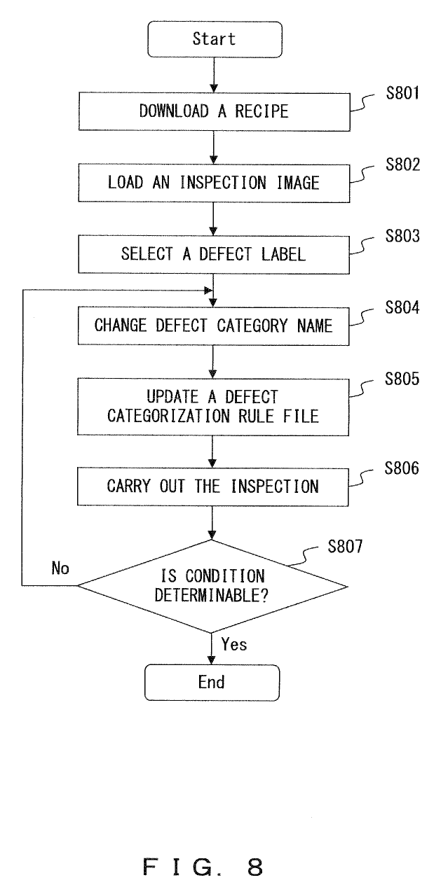

FIG. 8 is a flow chart showing the flow of the process for updating a rule file.

First in S801, a recipe is downloaded onto the recipe server 7 in S801, and the image(s) inspected in accordance with the recipe downloaded in S801 and the downloaded images are listed in S802.

Then in S803, one image as the object of inspection is selected from among a plurality of inspection image list that has been listed up in S802 on the basis of the instruction of the operator and a defect label is selected from among the inspection result images.

Then in S804, defect category names are changed by way of the select field 406 shown in FIG. 7. Then in S805, the defect categorization rule file is updated, and in S806, the inspection is carried out.

Lastly in S807, while judging the result of the inspection carried out in S806, the tuning is repeated until the categorization that matches the purpose, and upon discovering a good condition the present process ends.

This operation creates a rule file capable of categorizing defects always appropriately, making it possible to generate an important material in terms of finding out the cause of a defect.

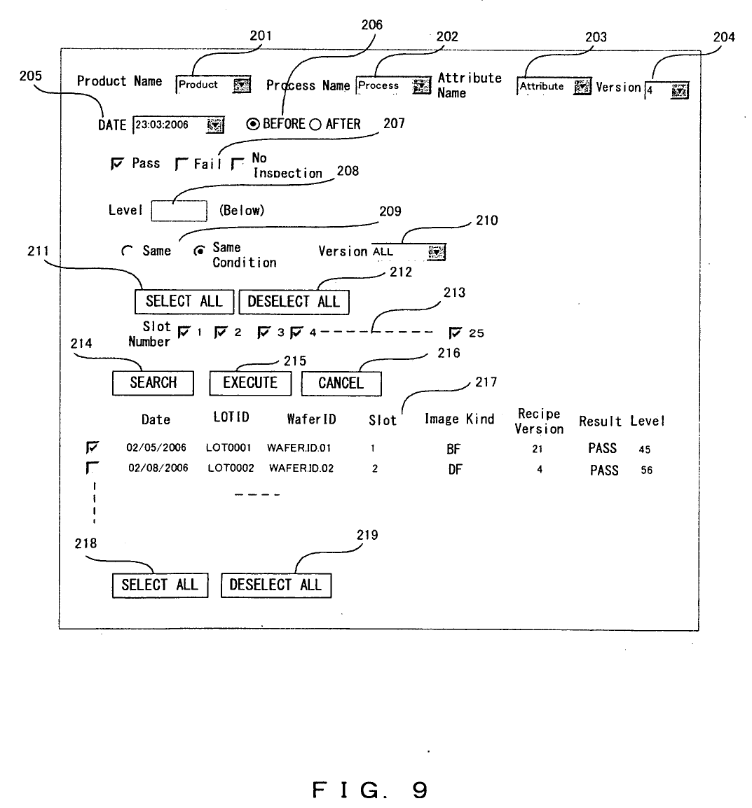

FIG. 9 is a diagram showing a search screen used for searching for an inspection image.

Referring to FIG. 4, select fields 201, 202, 203 and 204 respectively represent the product name, process name, attribute name and version number, which together constitute a recipe name. A select field 205 represents the date of inspection, while a radio button 206 is a radio button indicating either before or after the date designated by the select field 205. A check box 207 is the check box allowing designation that the inspection result is either Pass, Fail, or it is not inspected, when an inspection image is searched for. An edit box 208 is the edit box used for entering a level (i.e., a minimum value which is not detected as a defect). A radio button 209 is the radio button used for designating whether to list up the images inspected with the recipe specified by way of the select fields 201 through 204 or to list up also the images inspected with the recipe differently specified by way of the select field 204 while likewise specified by way of the select fields 201 through 203. A combo box 210 is the combo box used for specifying a version of the recipe.

A select button 211 is a button used for selecting all of check boxes 213 (described later), while a select button 212 is a button used for deselecting the selected all of the check boxes 213. The check box 213 is a check box used for designating a Slot Number. A select button 214 is a button used for starting a search under the condition specified through select field 201 through select button 211, while a select button 216 is a button used for cancelling the inspection. The result of carrying out a search initiated by the select button 214 is listed in a table list 217.

A select button 218 is a button used for selecting all inspection images listed in the table list 217, while a select button 219 is a button used for deselecting all of the selected. A select button 215 is a button used for loading the image for which the check box is checked (“v”), among the inspection images listed in the table list 217. The inspection date is selected in the select field 205 and radio button 206. An inspection result is selected in the check box 207. A Level is specified in the edit box 208 (if nothing is entered, all levels are made to be objects), a condition is selected in the radio button 209, and a version is selected in the combo box 210. Then an image is loaded by the following actions, i.e., selecting a slot number from the check box 213, clicking the search button of the select button 214, selecting the necessary number of the inspection images displayed in the table list 217, and clicking the button of the select button 215.

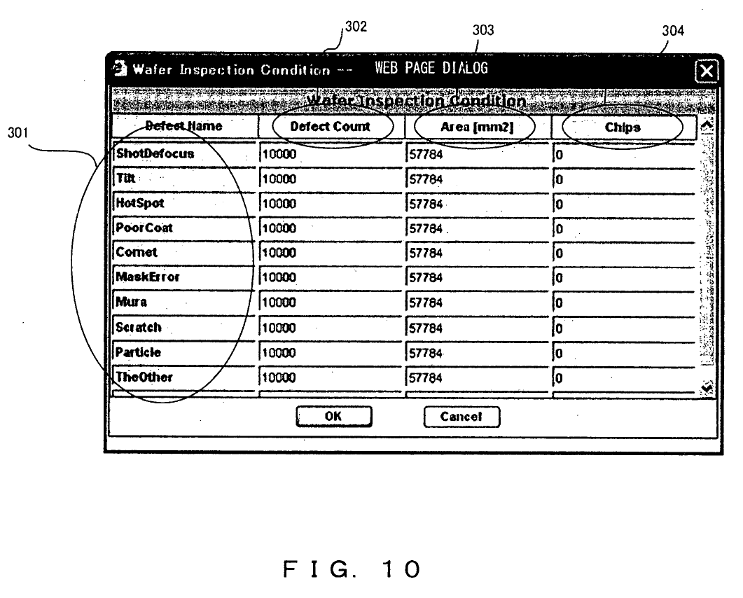

FIG. 10 is a diagram showing a screen for setting three kinds of inspection judgment threshold values for each defect category name in a threshold value setup for each category of defect.

An area 301 represents defect category names; an area 302 the number of defects; an area 303 the area size of defects; and an area 304 the number of defective chips. Threshold values for the areas 302 and 303 are set for each defect category name of the area 301.

While each preferred embodiment of the present invention has been described thus far with reference to the accompanying drawings, it shall be clear that the substrate inspection apparatus and the recipe server, to both of which the present invention is applied, are not limited to the above described individual embodiments, and may rather alternatively be configured as the respective singular apparatuses, or individual systems or integrated apparatuses constituted by a plurality of apparatuses, or individual systems in which the processing is carried out by way of a network such as a local area network (LAN), a wide area network (WAN), et cetera, provided that the respective functions of the substrate inspection apparatus and recipe server are attained.

That is, the present invention may be embodied in various configurations and forms, which are possible within the scope and spirit of the present invention, in lieu of being limited to the individual preferred embodiments described above.

The present invention is contrived to perform the update of a recipe, the update carried out by a recipe server that is connected to a substrate inspection apparatus in the midst of the process of inspecting a substrate, the process performed by the substrate inspection apparatus, and thereby it is possible to increase the throughput of the entirety of an inspection process produced by the substrate inspection apparatus and also carry out appropriate inspection continuously.

What is claimed is:

1. A defect inspection method used when a substrate belonging to a new product class is inspected at a defect inspection system to which both a substrate inspection apparatus used for inspecting a defect or defects by sequentially picking up respective images of a plurality of substrates and a recipe server used for setting a recipe to be utilized for the substrate inspection apparatus are connected by way of a network, the method including:
an inspection region setup process for designating at least the inspection region of a substrate as the initial setting of the recipe for the substrate belonging to a new product class, the setting performed by the recipe server in the midst of inspecting another substrate belonging to another product class;
an optical condition setup process for setting an optical condition for the image pickup;
a tentative inspection process for the substrate inspection apparatus obtaining image data by picking up the image of the substrate using a tentative recipe including the inspection region and optical condition which are designated by the recipe server;
a recipe tuning process for generating an adjusted recipe by modifying the tentative recipe using image data obtained by the substrate inspection apparatus, the process performed by the recipe server; and
a main inspection process for the substrate inspection apparatus inspecting the substrate belonging to the new product class on the basis of the adjusted recipe modified by the recipe server.

2. The defect inspection method according to claim 1, wherein
the optical condition setup process includes a pre-set image pickup mode(s), wherein the image pickup mode is selected for the optical condition.

3. The defect inspection method according to claim 2, wherein
the image pickup mode includes an imaging numerical value which is input for each image pickup mode selected by an inspector in the optical condition setup process.

4. The defect inspection method according to claim 1, wherein
the tentative recipe further includes both a defect detection condition for detecting a defect, and a defect categorization condition for categorizing a detected defect or defects, wherein
the recipe tuning process modifies any of the defect detection condition, defect categorization condition and optical condition.

5. The defect inspection method according to claim 1, wherein
the recipe tuning process modifies a defect categorization rule file to be used when a detected defect is categorized in accordance with a prescribed categorization rule, in addition to modifying the tentative recipe.

6. The defect inspection method according to claim 1, wherein
the recipe tuning process designates a defect judgment threshold value for each of the regions, that is, the edge region, extra region and scribe region of a semiconductor wafer which is the substrate, of a chip which is the object of inspection, and designates as to whether each of the regions is valid or invalid.

7. The defect inspection method according to claim 1, wherein
the recipe tuning process outputs a tuning result and carries out a tuning once again.

8. The defect inspection method according to claim 1, wherein
the inspection region setup process designates a defect region detected in a previous process detected in the same substrate as un-inspecting region.

9. The defect inspection method according to claim 1, wherein
the main inspection process updates a recipe to an adjusted recipe modified by the recipe server when product lots are changed over and inspects the substrate.

10. The defect inspection method according to claim 1, wherein
the recipe tuning process discretionarily selects image data obtained with a different recipe version and carries out tuning using the selected image data.

11. The defect inspection method according to claim 1, wherein
the substrate inspection apparatus uses a recipe designated in a mode to not extract a defect, thereby obtaining only an image.

12. The defect inspection method according to claim 1, wherein
the recipe tuning process designates the number of defects, the area size of a defect and the number of defective chips for each defect category and judges the result of inspection on the basis of each designated value.

13. The defect inspection method according to claim 1, wherein
the recipe tuning process is enabled to specify a Level as a search key used when an inspection image is searched for.
